(19) United States
(12) Patent Application Publication
(10) Pub. No.: US 2018/0248212 A1
(43) Pub. Date: Aug. 30, 2018

(54) FUEL CELL FOR OPTIMISING AIR HUMIDIFICATION

(71) Applicant: COMMISSARIAT A L'ENERGIE ATOMIQUE ET AUX ENERGIES ALTERNATIVES, Paris (FR)

(72) Inventors: Remi VINCENT, Grenoble (FR); Bertrand HLADYS, Mouxy (FR); Denis TREMBLAY, Pommiers-la-Placette (FR)

(73) Assignee: COMMISSARIAT A L'ENERGIE ATOMIQUE ET AUX ENERGIES ALTERNATIVES, Paris (FR)

(21) Appl. No.: 15/754,627

(22) PCT Filed: Aug. 9, 2016
(86) PCT No.: PCT/FR2016/052054

§ 371 Date: Feb. 23, 2018

(30) Foreign Application Priority Data
Aug. 24, 2015 (FR) 1557888

(51) Int. Cl. H01M 8/1004; H01M 8/0202; H01M 8/1007; H01M 4/86; H01M 8/04119

(52) U.S. Cl. CPC H01M 8/1004; H01M 8/0202; H01M 8/1007; H01M 2250/20; H01M 8/04171; H01M 8/04149; H01M 4/8663

(57) ABSTRACT

A fuel cell including: a membrane-electrode assembly including: a proton-exchange membrane, and a cathode in contact with a first surface of the membrane; two bipolar plates between which the membrane-electrode assembly is arranged, the bipolar plates including at least one first flow collector passing through same, in communication with the cathode; the membrane-electrode assembly includes a first active area covered by the cathode, and a first connection area not covered by the cathode and arranged between the first flow collector and the first active area; the membrane-electrode assembly also includes a first hydrophilic component arranged in the first connection area.

The invention relates to fuel cells and more particularly to fuel cells including bipolar plates between which is positioned a membrane/electrode assembly comprising a proton exchange membrane.

Fuel cells are envisioned in particular as energy source for motor vehicles produced on a large scale in the future or as auxiliary energy source in the aeronautical industry. A fuel cell is an electrochemical device which converts chemical energy directly into electrical energy. A fuel cell comprises a stack of several cells in series. Each cell typically generates a voltage of the order of 1 volt and the stack thereof makes it possible to generate a supply of voltage of a higher level, for example of the order of approximately a hundred volts.

Mention may in particular be made, among the known types of fuel cells, of the fuel cell comprising a proton exchange membrane, known as PEM, operating at low temperature. Such fuel cells exhibit particularly advantageous properties of compactness. Each cell comprises an electrolytic membrane which allows only protons and not electrons to pass. The membrane comprises an anode on a first face and a cathode on a second face, in order to form a membrane/electrode assembly (MEA). The membrane generally comprises, at its periphery, two reinforcements attached to respective faces of this membrane.

At the anode, molecular hydrogen, used as fuel, is ionized to product protons, which pass through the membrane. The membrane thus forms an ion conductor. The electrons produced by this reaction migrate toward a flow plate and then pass through an electrical circuit, external to the cell, to form an electric current. At the cathode, oxygen is reduced and reacts with the protons to form water.

The fuel cell can comprise several “bipolar” plates, for example made of metal, stacked on one another. The membrane is positioned between two bipolar plates. The bipolar plates can comprise flow channels and orifices for continuously guiding the reactants and the products toward/from the membrane. The bipolar plates also comprise flow channels for guiding cooling liquid which discharges the heat produced. The reaction products and the nonreactive entities are discharged by entrainment by the flow as far as the outlet of the networks of flow channels. The flow channels of the different flows are separated via bipolar plates in particular.

The bipolar plates are also electrically conductive in order to collect electrons generated at the anode. The bipolar plates also have a mechanical role of transmitting the strains of damping of the stack, necessary for the quality of the electrical contact. Gas diffusion layers are interposed between the electrodes and the bipolar plates and are in contact with the bipolar plates.

Electron conduction is carried out across the bipolar plates, ion conduction being obtained across the membrane.

The document US2011/0305960 describes a fuel cell, comprising:
a membrane/electrode assembly including a proton-exchange membrane and a cathode in contact with a first face of the membrane;
two bipolar plates between which the membrane/electrode assembly is positioned, said bipolar plates being traversed by at least one first flow collector in communication with said cathode;
the membrane/electrode assembly comprises a first active region covered by said cathode.

A hydrophilic component is positioned in a flow collector.

The document EP 1 036 422 describes a fuel cell stack combined with a humidification device with reversal of the flow stream at the cathode. The document describes the reversal of the flow stream and the incorporation of a device for capturing water outside of the stack, in order to store water to be released during the reversal.

The document FR 2 398 392 describes a hydrophilic material positioned on the surface of bipolar plates.

The document US2012/052207 describes bipolar plates coated with a hydrophilic material.

Some designs of bipolar plates use homogenization regions for connecting inlet and outlet collectors to the different flow channels of the bipolar plates. The reactants are brought into contact with electrodes from inlet collectors and the products are discharged from outlet collectors connected to the different flow channels. The inlet collectors and the outlet collectors generally pass right through the thickness of the stack. The inlet and outlet collectors are usually obtained by:
respective orifices traversing each bipolar plate at its periphery;
respective orifices traversing each membrane and its reinforcements at its periphery;
seals, each interposed between a bipolar plate and a reinforcement.

Various technical solutions are known for bringing the inlet and outlet collectors into communication with the various flow channels. In particular, it is known to produce passages between two metal sheets of a bipolar plate. These passages emerge, on the one hand, in orifices of respective collectors and, on the other hand, in injection orifices. A homogenization region comprises channels which bring injection orifices into communication with flow channels.

The homogenization region generally comprises: a cooling fluid transfer region, an oxidant circuit homogenization region and a fuel circuit homogenization region which are superimposed and which respectively emerge toward a cooling liquid collector, an oxidant circuit collector and a fuel circuit collector. The disadvantage of the homogenization regions is the surface area which they occupy without participating in the electrochemical reactions; the homogenization regions typically cover between 5% and 10% of the surface area of the active region, including the flow channels for the reactants.

Furthermore, a sufficient level of humidity at the air inlet is desirable in order to optimize the operation and the lifetime of the fuel cell. Sufficient humidity is desirable in particular in order to reduce the hydric stresses on the proton exchange membrane, the cause of ruptures of membranes. In order to obtain air humidification, it is known to add an air humidifier to the fuel cell. Such an air humidifier assumes an expensive and energy-devouring pumping system.

The invention is targeted at solving one or more of these disadvantages. The invention thus relates to a fuel cell as defined in the appended claims.

Other characteristics and advantages of the invention will become more dearly apparent from the description which is made thereof below, by way of indication and without any limitation, with reference to the appended drawings, in which:

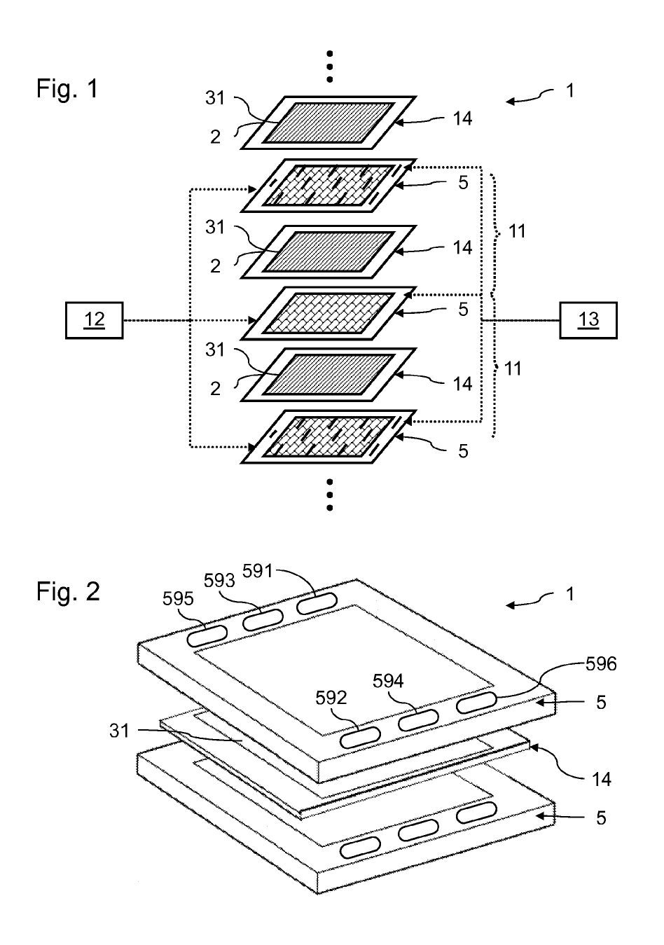

FIG. 1 is an exploded perspective view of an example of a stack of membrane/electrode assemblies and of bipolar plates for a fuel cell;

FIG. 2 is an exploded perspective view of bipolar plates and of a membrane/electrode assembly which are intended to be stacked in order to form flow collectors across the stack;

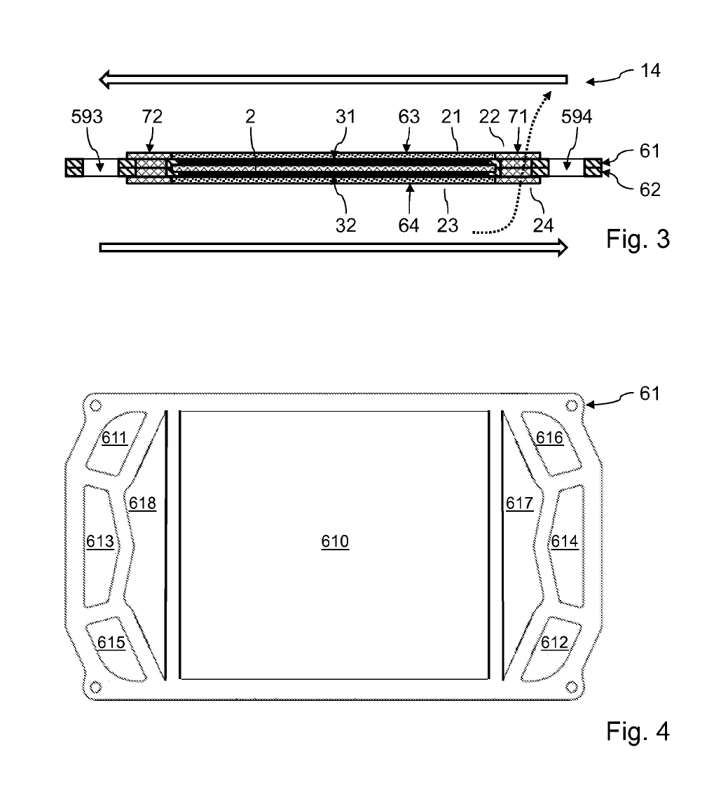

FIG. 3 is a diagrammatic view in longitudinal section of the membrane/electrode assembly of an implementational example of a first embodiment of a fuel cell according to the invention;

FIG. 4 is a top view of a reinforcement of the membrane/electrode assembly of FIG. 3;

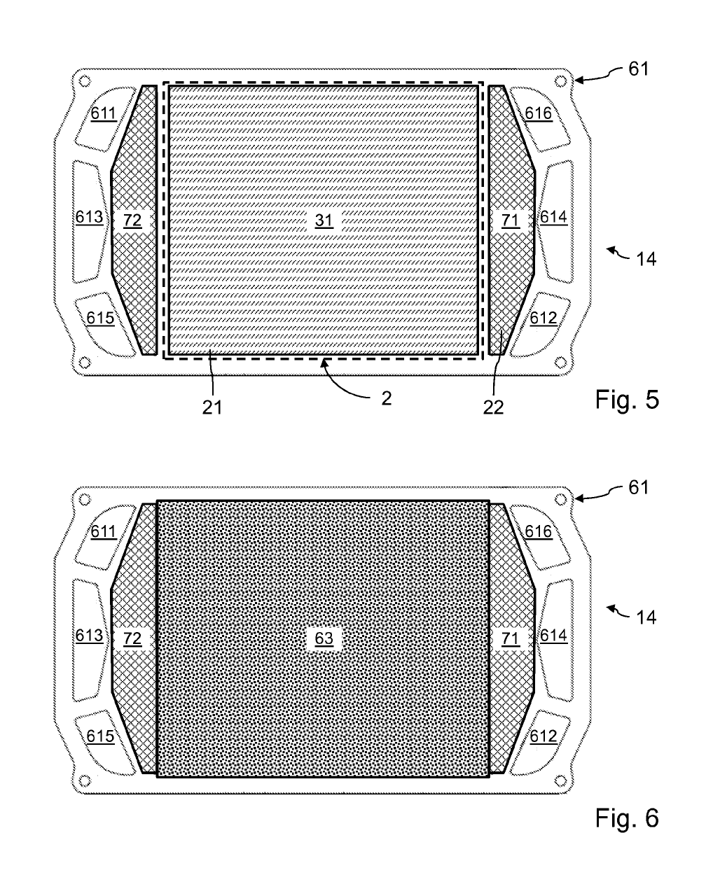

FIG. 5 is a diagrammatic top view of the reinforcement of FIG. 4 in combination with a membrane, electrodes and hydrophilic elements;

FIG. 6 is a top view of the set of FIG. 5, in combination with gas diffusion layers;

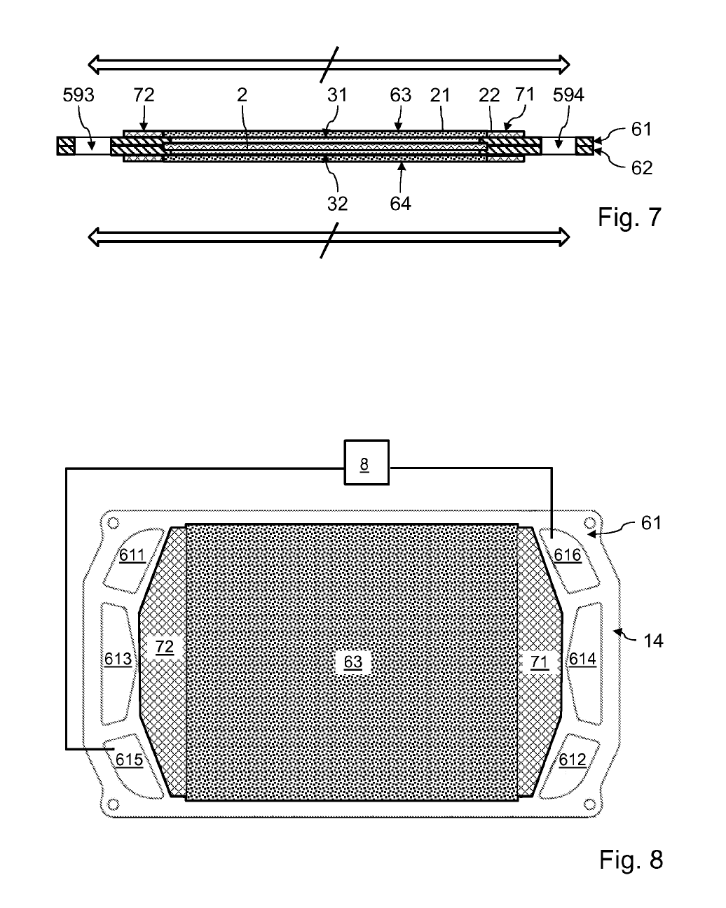

FIG. 7 is a diagrammatic view in longitudinal section of the membrane/electrode assembly of an implementational example of a second embodiment of a fuel cell according to the invention;

FIG. 8 is a diagrammatic top view of a reinforcement in combination with a membrane, electrodes and hydrophilic elements for the membrane/electrode assembly of FIG. 7.

FIG. 1 is a diagrammatic exploded perspective view of a stack of individual cells 11 of a fuel cell 1. The fuel cell 1 comprises several superimposed individual cells 11. The individual cells 11 are of the type comprising a proton exchange membrane or a polymer electrolyte membrane.

The fuel cell 1 comprises a source of fuel 12. The source of fuel 12 feeds, in this instance, an inlet of each individual cell 11 with molecular hydrogen. The fuel cell 1 also comprises a source of oxidant 13. The source of oxidant 13 feeds, in this instance, an inlet of each individual cell 11 with air, the oxygen of the air being used as oxidant. Each individual cell 11 also comprises exhaust channels. One or more individual cells 11 also exhibit a cooling circuit.

Each individual cell 11 comprises a membrane/electrode assembly 14 or MEA 14. A membrane/electrode assembly 14 comprises an electrolyte 2, a cathode 31 and an anode (not illustrated) placed on either side of the electrolyte and attached to this electrolyte 2. The layer of electrolyte 2 forms a semi-permeable membrane which makes possible proton conduction while being impermeable to the gases present in the individual cell. The layer of electrolyte also prevents the electrons from passing between the anode and the cathode 31.

A bipolar plate 5 is positioned between each pair of adjacent MEAs. Each bipolar plate 5 defines anode flow channels and cathode flow channels. Bipolar plates also define cooling liquid flow channels between two successive membrane/electrode assemblies.

In a way known per se, during the operation of the fuel cell 1, air flows between an MEA and a bipolar plate 5 and molecular hydrogen flows between this MEA and another bipolar plate 5. At the anode, molecular hydrogen is ionized to product protons, which pass through the MEA. The electrons produced by this reaction are collected by a bipolar plate 5. The electrons produced are subsequently applied to an electric charge connected to the fuel cell 1 in order to form an electric current. At the cathode, oxygen is reduced and reacts with the protons to form water. The reactions at the anode and the cathode are governed as follows:

H₂→2H⁺+2e⁻ at the anode;

4H⁺4e⁻+O₂→2H₂O at the cathode.

During the operation thereof, an individual cell of the fuel cell usually generates a direct current between the anode and the cathode of the order of 1 V.

FIG. 2 is a diagrammatic exploded perspective view of two bipolar plates 5 and of a membrane/electrode assembly which are intended to be included in the stack of the fuel cell 1. The stack of the bipolar plates 5 and of the membrane/electrode assemblies 14 is intended to form a plurality of flow collectors, the arrangement of which is illustrated in this instance solely diagrammatically. To this end, respective orifices are inserted across the bipolar plates 5 and across the membrane/electrode assemblies 14. The MEAs 14 comprise reinforcements (not illustrated) at their periphery.

The bipolar plates 5 thus comprise orifices 591, 593 and 595 at a first end and orifices 592, 594 and 596 at a second end opposite the first end. The orifice 591 is used, for example, to form a collector for supplying with fuel, the orifice 592 is used, for example, to form a collector for discharging combustion residues, the orifice 594 is used, for example, to form a collector for supplying with cooling liquid, the orifice 593 is used, for example, to form a collector for discharging cooling liquid, the orifice 596 is used, for example, to form a collector for supplying with oxidant and the orifice 595 is used, for example, to form a collector for discharging water of reaction.

The orifices of the bipolar plates 5 and of the membrane/electrode assemblies 14 (i.e., the orifices inserted in the reinforcements, which are not illustrated) are positioned facing each other in order to form the various flow collectors.

FIG. 3 is a side section view of a membrane/electrode assembly for a fuel cell according to an exemplary embodiment of the invention. The membrane/electrode assembly 14 includes the membrane 2, a cathode 31 and an anode 32 which are integrally attached on either side of the membrane 2. The composition and the structure of the cathode 31 or of the anode 32 are known per se to a person skilled in the art and will not be further described in detail. The membrane/electrode assembly 14 additionally includes reinforcements 61 and 62. The reinforcements 61 and 62 are attached to the periphery of respective faces of the membrane 2. A gas diffusion layer 63 is in contact with the cathode 31 through a median orifice inserted through the reinforcement 61. A gas diffusion layer 64 is in contact with the anode 32 through a median orifice inserted through the reinforcement 62.

A bipolar plate faces the gas diffusion layer 63 and comprises flow channels for guiding an oxidant, such as air, along the direction illustrated by the upper arrow. The cathode 31 defines an active region 21 in which the cathode electrochemical reaction occurs. A connecting region or homogenization region 22 is inserted between the active region 21 and the flow collectors 592, 594 and 596. The connecting region 22 is intended in a way known per se to homogenize the flow of oxidant between the collector 596 and the cathode flow channels.

Another bipolar plate faces the gas diffusion layer 64 and comprises flow channels for guiding a fuel, such as molecular hydrogen, along the direction illustrated by the lower arrow. The anode 32 defines an active region 23 in which the anode electrochemical reaction occurs. A connecting region or homogenization region 24 is inserted between the active region 23 and the flow collectors 592, 594 and 596. The connecting region 24 is intended, in a way known per se, to homogenize the flow of fuel between the anode flow channels and the collector 592.

Although not illustrated, seals insulate the anode and cathode flow channels with respect to the flow in the flow collectors 593 and 594.

On following the cathode flow channels, the chemical reaction produces water, which increases the humidity in the flow. However, the air present at the inlet of the cathode 31 potentially exhibits a greatly reduced level of humidity.

According to this embodiment, a hydrophilic component 71 is inserted in order to form a hydric junction between the connecting region 24 and the connecting region 22. Such a hydric connection makes it possible to allow moisture present at the anode flow outlet to pass through toward the inlet of the cathode flow, as illustrated by the arrow rendered in dots. The moisture thus recovered at the cathode flow inlet makes it possible to humidify the membrane 2 and to reduce the stresses on the latter, even in the absence of an external circuit for humidification of the oxidant flow. This humidification of the cathode flow is in addition carried out in a region which is not active for the electrochemical reaction, which makes it possible to benefit from an additional role in this region. In order to optimize the use of a connecting region 22, the hydrophilic component 71 advantageously occupies at least half of the surface area of the connecting region.

In order to avoid an electrochemical reaction in the hydrophilic component 71 which would risk bringing about the disappearance of the water and the drying out of the cathode flow, the cathode 31 does not cover the connecting region 22. Likewise, the anode 32 does not cover the connecting region 24. In order to avoid or to limit any electrochemical reaction in the connecting regions 22 and 24, the hydrophilic component 71 is either devoid of catalyst material or exhibits at most an amount of catalyst equal to 1 μg/cm².

In the example illustrated, a connecting or homogenization region is advantageously inserted between the active region 21 and the flow collectors 591, 593 and 595, and another connecting or homogenization region is advantageously inserted between the active region 23 and flow collectors 591, 593 and 595. A hydrophilic component 72 is advantageously inserted in order to form a hydric junction between these last connecting regions. Such a hydric connection makes it possible to allow moisture present at the cathode flow outlet to pass through toward the inlet of the anode flow, which moisture can again pass through the hydrophilic component 71 to reach the inlet of the cathode flow.

In order to avoid a detrimental subsidiary flow of molecular hydrogen or of molecular oxygen across the hydrophilic components 71 and 72 inserted between the connecting regions, these hydrophilic components 71 and 72 are impermeable to the gases.

The hydrophilic component 71 and/or the hydrophilic component 72 can include (typically more than 50% by weight) or consist of one of the following materials: colloidal silica, bentonite or a polymer of perfluorosulfonic acid type. The hydrophilic component 71 and/or the hydrophilic component 72 can advantageously be made of the same material as the membrane 2. The hydrophilic component 71 and/or the hydrophilic component 72 can advantageously be made with a binder, such as carboxymethylcellulose or a polyvinyl alcohol.

The hydrophilic component 71 and/or the hydrophilic component 72 can be made of a material exhibiting a diffusion of water of at least 0.1 mg/s·cm² and at most of 0.5 mg/s·cm².

The hydrophilic components 71 and 72 advantageously exhibit a thickness which is greater than that of the membrane 2.

Advantageously, in order to promote the passage of the moisture across the components 71 and 72, the component 71 and/or the component 72 are not covered with the gas diffusion layers 63 and 64.

FIG. 4 is a top view of an example of reinforcement 61 which can be employed in the membrane/electrode assembly of FIG. 3. FIG. 5 is a top view of the membrane/electrode assembly 14 devoid of gas diffusion layer. FIG. 6 is a top view of the membrane/electrode assembly 14 provided with the gas diffusion layer 63. The reinforcement 62 can exhibit a structure identical to that of the reinforcement 61. The reinforcement 61 is provided here in the form of an openwork layer. The reinforcement 61 is, for example, made of polymer material known per se. The reinforcement 61 comprises, in a way known per se, a median opening 610 intended to reveal the major part of the cathode 31. The reinforcement 61 furthermore surrounds this cathode 31.

The reinforcement 61 furthermore comprises orifices 611, 613 and 615 inserted to one side with respect to the median opening 610. The orifices 611, 613 and 615 are intended to be positioned facing the orifices 591, 593 and 595 of the bipolar plates 5. An orifice 618 is inserted between the orifices 611, 613, 615 and the median orifice 610. The orifice 618 is intended to be traversed by the hydrophilic component 72. The reinforcement 61 comprises orifices 612, 614 and 616 inserted on the opposite side from the orifices 611, 613 and 615, with respect to the median opening 610. The orifices 612, 614 and 616 are intended to be positioned facing the orifices 592, 594 and 596 of the bipolar plates 5. An orifice 617 is inserted between the orifices 612, 614, 616 and the median orifice 610. The orifice 617 is intended to be traversed by the hydrophilic component 71.

As illustrated in this instance, the hydrophilic component 71 advantageously covers the edge of the reinforcement 61 delimiting the orifice 617.

FIG. 7 is a side section view of a membrane/electrode assembly for a fuel cell according to an example of another embodiment of the invention. FIG. 8 is a diagrammatic top view of the membrane/electrode assembly 14 in combination with a device 8 described in detail subsequently.

The membrane/electrode assembly 14 includes the membrane 2, a cathode 31 and an anode 32 which can be identical to those of the preceding embodiment. The membrane/electrode assembly 14 also includes reinforcements 61 and 62 attached to the periphery of respective faces of the membrane 2. The membrane/electrode assembly 14 additionally comprises gas diffusion layers 63 and 64 which can be identical to those of the preceding embodiment.

A bipolar plate faces the gas diffusion layer 63 and comprises flow channels for guiding an oxidant, such as air. The cathode 31 defines an active region 21 in which the cathode electrochemical reaction occurs. A connecting region or homogenization region 22 is inserted between the active region 21 and the flow collectors 592, 594 and 596.

Another bipolar plate faces the gas diffusion layer 64 and comprises flow channels for guiding a fuel, such as molecular hydrogen. The anode 32 defines an active region 23 in which the anode electrochemical reaction occurs. A connecting region or homogenization region 24 is inserted between the active region 23 and the flow collectors 592, 594 and 596.

Although not illustrated, seals insulate the anode and cathode flow channels with respect to the flow in the flow collectors 593 and 594.

Hydrophilic components 71 and 72 are positioned in the cathode junction regions on either side of the active region 21. In this embodiment, the hydrophilic components 71 and 72 do not pass through the reinforcements 61 and 62. The reinforcements 61 and 62 are thus hermetically sealed at the hydrophilic components 71 and 72. The hydrophilic components 71 and 72 are in this instance intended to store moisture for a respective flow direction and are then intended to restore this moisture for a reversed respective flow direction.

To this end, a device 8 is configured in order to alternately generate a flow of oxidant from the flow collector 591 toward the flow collector 596 and a flow of oxidant from the flow collector 596 toward the flow collector 591. When the oxidant flows from the flow collector 591 toward the flow collector 596: the hydrophilic component 71 absorbs moisture at the flow outlet, whereas the hydrophilic component 72 restores it at the inlet. When the oxidant flows from the flow collector 596 toward the flow collector 591: the hydrophilic component 72 absorbs moisture at the flow outlet, whereas the hydrophilic component 71 restores it at the inlet.

Advantageously, the device 8 is configured in order to reverse the direction of flow between the flow collectors 591 and 596 with a period of between 10 and seconds. Such a period can prove to be sufficient to absorb the moisture at the oxidant flow outlet.

1-11. (canceled)

12: A fuel cell, comprising:
a membrane/electrode assembly including a proton exchange membrane, and a cathode in contact with a first face of the membrane;
two bipolar plates between which is positioned the membrane/electrode assembly, the bipolar plates being traversed by at least one first flow collector in communication with the cathode;
the membrane/electrode assembly includes a first active region covered by the cathode, and a first connecting region not covered by the cathode and positioned between the first flow collector and the first active region;
the membrane/electrode assembly further includes a first hydrophilic component positioned in the first connecting region.

13: The fuel cell as claimed in claim 12, wherein:
the bipolar plates are traversed by a second flow collector,
the membrane/electrode assembly includes an anode in contact with a second face of the membrane, the membrane/electrode assembly including a second active region covered by the anode and a second connecting region not covered by the anode and positioned between the second flow collector and the second active region;
the first hydrophilic component being impermeable to the gases and forming a hydric junction between the first and second connecting regions.

14: The fuel cell as claimed in claim 12, wherein:
the bipolar plates are traversed by a third flow collector in communication with the cathode;
the membrane/electrode assembly includes a third connecting region not covered by the cathode and positioned between the third flow collector and the first active region;
the membrane/electrode assembly further includes a second hydrophilic component positioned in the third connecting region;
the fuel cell includes a device configured to successively generate a flow of oxidant from the first flow collector toward the third flow collector and then from the third flow collector toward the first flow collector.

15: The fuel cell as claimed in claim 14, wherein the device is configured to reverse the direction of flow between the first and third flow collectors with a period of between 10 and 30 seconds.

16: The fuel cell as claimed in claim 12, further comprising a reinforcement attached to the membrane and to the first hydrophilic component, the reinforcement including a first orifice through which the first hydrophilic component is accessible and including a second orifice through which the cathode is accessible.

17: The fuel cell as claimed in claim 16, wherein the first hydrophilic component covers an edge of the reinforcement delimiting the first orifice.

18: The fuel cell as claimed in claim 12, wherein the first hydrophilic component includes a material chosen from the group colloidal silica, bentonite and a polymer of perfluorosulfonic acid type.

19: The fuel cell as claimed in claim 12, wherein the first hydrophilic component exhibits a diffusion of the water of at least 0.1 mg/s·cm², and at most of 0.5 mg/s·cm².

20: The fuel cell as claimed in claim 12, further comprising a gas diffusion layer in contact with the cathode, the gas diffusion layer not extending as far as vertical with the first hydrophilic component.

21: The fuel cell as claimed in claim 12, wherein the first hydrophilic component includes an amount of catalyst material at most equal to 1 μg/cm².

22: The fuel cell as claimed in claim 12, wherein the first hydrophilic component occupies at least half of the surface area of the first connecting region.
